(19) United States
(12) Patent Application Publication
(10) Pub. No.: US 2005/0273708 A1
(43) Pub. Date: Dec. 8, 2005

(54) Content-based automatic file format indetification

(75) Inventors: Daniel Richard Motyka, Calgary (CA); Robert Norman Walker, Calgary (CA); Marvin Mah, Calgary (CA)

Correspondence Address: William L. Botjer, PO Box 478, Center Moriches, NY, 11934, US

(73) Assignee: VERITY, INC., SUNNYVALE, CA (US)

(21) Appl. No.: 10/859,937

(22) Filed: Jun. 3, 2004

(51) Int. Cl. G06F 17/21

(52) U.S. Cl. 715/515

(57) ABSTRACT

A method and system for content-based, automatic file format identification. The invention also relates to a method and system for dynamically selecting a set of bytes for byte-pattern recognition. The invention matches the pre-selected number of bytes of a file with the data signature of selected file formats. The file format information provided by the meta-data linked to the file acts as a filter that selects the file formats, which match the file information. If the attempt for file format identification, mentioned above, is unsuccessful, the invention computes the data type of the file, and subsequently identifies the corresponding text or binary file type. If a compound data type is computed, the invention identifies the file formats present in the compound file format.

### BACKGROUND

The present invention relates to the field of file format identification, in particular to a method and system for content-based, automatic file format identification.

File format identification is a salient feature of each software program, and is performed while conducting multiple operations. The operations vary from loading and identifying files on a host computer, to downloading and streaming files in a network. The growth in the customized software market has introduced myriad software-specific file formats. This increase in the number of file formats has made file format identification even more complex for software programs.

Many techniques have been developed to handle the problem of the increasing number of file formats. A conventional way of solving this problem is to identify and use a standard file format. In fact, most software programs still support a particular set of file formats. Such software programs have limitations, since they can only read file formats they recognize. Moreover, these software programs give an error message when directed to process a file of an unsupported file format.

Another common approach is to statically associate a file extension to a particular application—a form of external file format meta-data. This solution is familiar to the users of Microsoft Windows™ operating system. Variants of this solution include downloading the mappings over a network at login time, or even the runtime registration of an application to a format, or vice versa. In all of these cases, the know-how that maps a data format to an application is statically defined, and so the mapping will not be registered if the specific application is not installed on the target machine.

In addition, these static format-application mappings are error prone due to inconsistencies in implementation and lack of standards. Moreover, when files are delivered as streams, the application is forced to process the incoming data with the assumption that it adheres to the expected format. For example, consider a case when a compound file (a file containing one or more files) format is acceptable by an application but the format of a file present in the compound file is not. In such a case, the application assumes that the format of the file in the compound file is acceptable and processes it accordingly. At a later stage, this may lead to an error in processing the file.

Improved techniques for file format identification include statistical analysis of known file formats. This technique is described in the research paper by Mason McDaniel and M. Hossain Heydari, titled ‘Content Based File Type Detection Algorithm’. The paper was published in the 36'th Annual Hawaii International Conference on System Science, on Jan. 6, 2003. The paper relates to a threefold approach to file format identification. In the first approach, the paper proposes a statistical analysis of all the known file types. This statistical analysis is based on the frequency of the occurrence of a byte in a particular file type. The technique generates normalized histograms for each file type and identifies a file type by matching the byte frequency histogram of the unknown file with that of the known files. In the second approach, correlation is established between characters used in a particular file format. For example, in an HTML document, the frequency of the occurrence of the character [<] is the same as that of the character [>]. This correlation enables more efficient file format identification. Finally, the paper also proposes a byte frequency histogram for the header and footer bytes of a file format. For file format identification, this technique compares the byte frequency histogram of the header and the footer of unknown files with that of known file formats.

However, a lot of training of file samples is required for the above-mentioned approach to work efficiently. Moreover, to identify an unknown file, the approach mentioned above parses the whole file for format identification. This makes the process of format identification both time consuming and less accurate. For example, the file format identification process mentioned in the research paper may have a problem in distinguishing between ‘xml’, ‘sgml’, ‘html’ and ‘xhtml’ file formats. This is because these formats use characters, which will give identical frequency distribution for the methods mentioned in the research paper.

Therefore, there is a need for an efficient method and system that does not depend on the meta-data for format identification. There is also a need for a method and system that does not parse the whole file for its identification.

### SUMMARY

An object of the present invention is to provide a method and system that selectively uses the content of a file and the external information linked to the file to determine the format of the file.

Another object of the present invention is to dynamically select a set of bytes for byte-pattern matching.

The file format identification system of the present invention performs content-based, automatic file format identification. The system also dynamically selects a set of bytes from a file for byte-pattern recognition.

The file format identification system of the present invention comprises a selection unit, a comparison unit, a verification unit, a detection unit, a data format identifier, an extraction unit, and a plurality of text file-based parsers.

The method for byte pattern recognition begins with checking relevant file format information in the meta-data linked to the input file. If relevant file format information is available, it is extracted from the meta-data. The selection unit identifies the file formats that match the relevant file format information and calculates the length (in bytes) of the longest data signature. A set of bytes is selected at the corresponding location in the input file and is compared to the corresponding data signature of the selected file formats. If relevant file format information is not available, the selection unit selects the length of bytes from a set of known file formats.

The method described above is also used for content-based, automatic file format identification. The file format identification begins by selecting a set of bytes at the beginning of the input file. The set of bytes is chosen by a process identical to the byte pattern recognition method described above. After the bytes have been selected, the comparison unit matches the set of selected bytes with the data signature of the known/selected file formats. The file formats for which the comparison is successful are verified by the verification unit, which performs verification by comparing the data structure of the file with that of the known/selected file formats. The mode selected for verification is chosen, based on the set of file format(s) for which the matching is successful. The detection unit then checks the file format that is verified for the presence of a compound file format. If the file format is identified to be compound, the file format identification system finds the format of the files present in the identified compound file format, otherwise the file format is returned as the format that represents the file.

However, if the matching is unsuccessful, or if the verification does not produce any relevant file format, the selection unit chooses a set of bytes at the end of the file and compares it with the corresponding data signature of the known file formats. The file formats for which the data signature matches the selected set of bytes are chosen, and verified. The matching and verification processes followed for the bytes at the end of the file, are the same as followed for the bytes at the beginning of the file. The detection unit then compares the file format verified with a list of known compound file formats. If the file format is identified to be compound, the file formats present in it are recursively identified, otherwise the file format is identified as the format that represents the file. If the comparison of the set of bytes at the end of the file is unsuccessful, or if verification does not yield at least one file format, the data format identifier checks the language and character set of the input file, to identify a textual file format. If the data type of the input file is identified to be textual, the extraction unit compares the file format-specific syntax and characters. This step is performed to select a list of possible representative textual file formats. Meta-data available with the file may be used to determine the language and character set of the file.

In the next step, parsers corresponding to the text file formats that match the content of the file parse the file. The file format for which the corresponding parser successfully parses the maximum length of the file is selected as the format of the file. In case the parsing is unsuccessful, meta-data is applied to the input file for file format identification. Whereas, if the data type of the input file is not textual, the file format identification system applies meta-data to the file to identify the corresponding file format. The step of applying meta-data to identify the format of the input file is only performed if meta-data has not been used previously to constrain the search space. If meta-data has been used previously, the meta-data and the file format selected are invalidated and file format detection is performed over a set of known file formats.

Once the file format is identified, the detection unit checks whether the file format is compound. If the file format is compound, the file formats present in the identified compound file format are identified. The result of the file format identification process is returned as a vector containing a full recursive description of the file formats detected.

In case no file format matches the input file, and the data type of the file is identified to be textual, the file format identification unit returns the input file as an unknown simple text file with no embedded control or markup instructions. Whereas, if the data type is identified to be non-textual, the file format identification unit returns the file format of the input file as unknown, and recommends a file format that best represents the input file.

### BRIEF DESCRIPTION OF THE DRAWINGS

The preferred embodiments of the invention will hereinafter be described in conjunction with the appended drawings provided to illustrate and not to limit the invention, wherein like designations denote like elements, and in which:

FIG. 1 illustrates the computing device embodying the file format identification system;

FIG. 2 illustrates the sub-components present in the file format identification system;

FIG. 3 illustrates a flowchart that describes the steps involved in dynamically selecting a set of bytes from a file for byte-pattern recognition; and

FIG. 4A, FIG. 4B and FIG. 4C illustrate a flowchart that describes the steps involved in the method for content-based, automatic file format identification.

### DESCRIPTION OF PREFERRED EMBODIMENTS

The present invention relates to a method and system for content-based, automatic file format identification. It aims at detecting a file format that represents an input file in the best possible manner. The input file may be a binary or text data type. The binary data type includes card data types, word documents and video types, while text data type includes print data types and XML. The invention also relates to a method and system for dynamically selecting a set of bytes from the input file for byte-pattern recognition. This byte-pattern recognition is further used in the method for content-based, automatic file format identification.

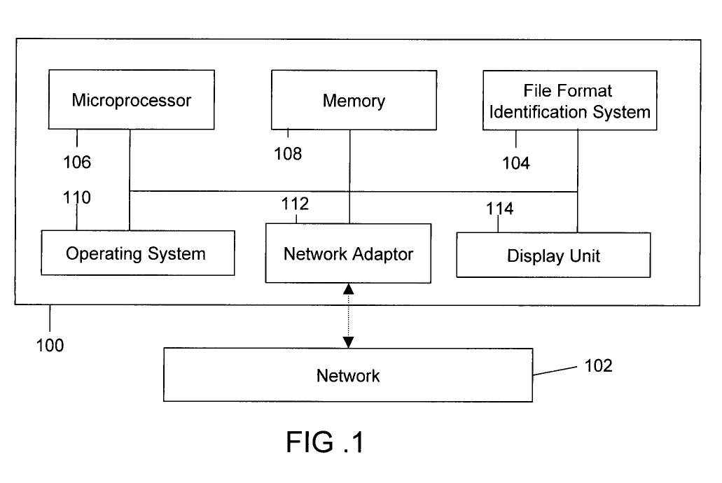

FIG. 1 illustrates the computing device embodying the file format identification system. The figure shows a computing device 100 capable of receiving, reading and processing data. Computing device 100 may be a computer, a mobile phone, a laptop, a palmtop, etc. Computing device 100 may receive data either from internal memory devices or from a network 102. Network 102 linked to the computing device may be the Internet, a Local Area Network (LAN), or a Wide Area Network (WAN), etc.

Computing device 100 comprises a file format identification system 104, a microprocessor 106, a memory device 108, an operating system 110, a network adaptor 112 for interacting with the network, and a display unit 212 for displaying the data. Computing device 100 may receive data either from memory device 108 or from the network. Memory device 108 may be a magnetic or optical storing media, such as a hard disk, a tape drive, a compatible disc (CD), or a memory chip, etc.

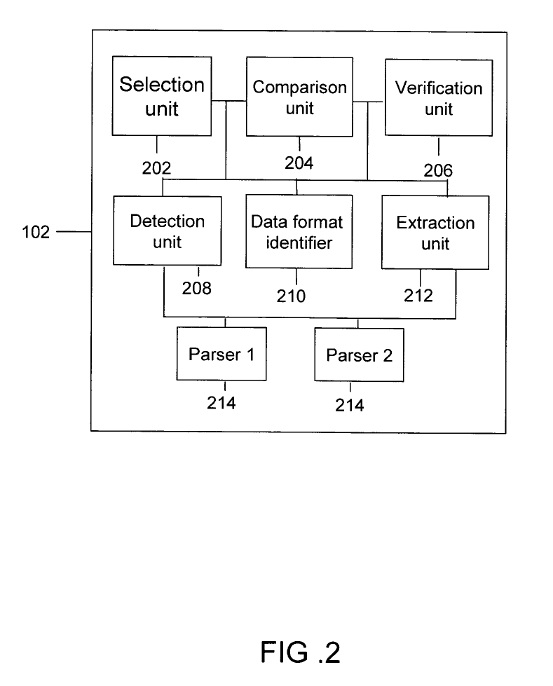

File format identification system 104 in one of its embodiments comprises sub-components, as described in FIG. 2. File format identification system 104 comprises a selection unit 202, a comparison unit 204, a verification unit 206, a detection unit 208, a data format identifier 210, an extraction unit 212, and a plurality of text-based parsers 214. Selection unit 202 identifies a set of bytes from a specific location in the input file, based on the length of the data signature of known file formats. The data signature of each known file format may be selected from a predefined location. Comparison unit 204 matches these data signatures (of the known file formats) with the byte-pattern of the set of bytes selected by selection unit 202. The comparison may be performed using various comparison functions known in the art. The comparison function may also further depend on the programming language chosen for enabling the disclosed invention. Verification unit 206 then verifies the file formats that match the byte-pattern of the input file. Detection unit 208 compares the file format identified with a list of compound file formats. In the disclosed invention, the textual file formats are separated from non-textual file formats. Data format identifier 210 identifies text file formats. Extraction unit 212 then picks up representative characters and syntax of the textual file formats (selected by data format identifier 210) and determines their formats. This step is performed by a plurality of parsers 214, wherein each parser 214 represents a text file format.

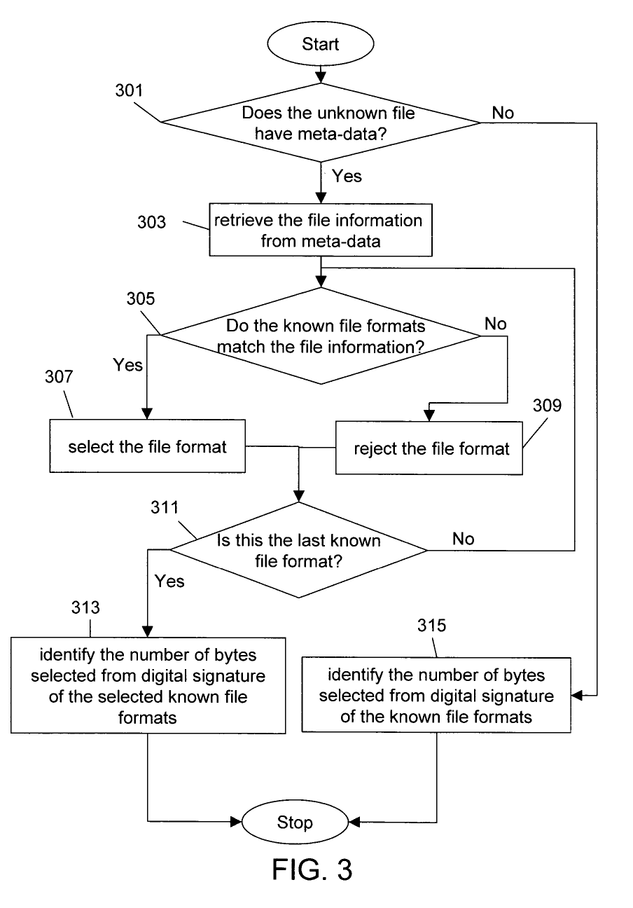

The steps involved in dynamically selecting a set of bytes for file format identification are described further with the help of FIG. 3. The method begins with step 301. In step 301, file format identification system 104 checks if relevant file format information is available with meta-data linked to the file. The meta-data may be an internal or an external meta-data. Examples of internal meta-data include items such as authors, titles or subjects, whereas external meta-data may include document content such as a MIME type from a web server, or an extension from the file system. In the case of compound file formats, the meta-data may include the manifest, directory, and/or document-typing information. A compound file format comprises one or more sub-file formats. An example of a compound file format is WinZip™, which can contain files of different file formats.

In step 301, if relevant file format information is available with the meta-data linked to the file, step 303 is performed. In step 303, file format identification system 104 extracts the relevant file format information from the meta-data linked to the file. The most general file information provided by the meta-data is the file extension itself. The file information may be extracted based on data extraction techniques known in the art. Once the file information is extracted, step 305 is performed.

In step 305, file format identification system 104 compares the known file formats to the relevant file format information provided by the meta-data. In the present invention, meta-data is used in an advisory fashion to select a set of known file formats that match the file information provided by the meta-data. The relevant file format information provided by the meta-data is used to constrain the sample set of file formats that are used for file format identification. For example, consider a situation when external MIME meta-data is available with a binary image file downloaded from the Internet, and the external meta-data indicates that the binary image file can run on the Microsoft Imaging™ application. The present pattern recognition algorithm selects the file formats supported by the Microsoft Imaging™ application (jpeg, bmp, and tiff file formats) for byte-pattern recognition.

In step 305, if a file format matches the file information provided by the meta-data, the file format is selected in step 307, for comparing its data signature to the byte-pattern of the input file. Otherwise, the file format is rejected in step 309. In step 311, file format identification system 104 performs a check if all known file formats have been compared to the file information provided by the meta-data. If the operation has been performed for all known file formats, the selected file formats of step 307 proceed to step 313, otherwise file format identification system 104 performs step 305, and compares the relevant file format information with the remaining file formats.

In step 313, selection unit 202 identifies the length of the longest data signature from the selected file formats. The data signature may be present at the beginning or at the end of the known file formats. The data signature of a file format represents the expected byte values at specific locations relative to the start of the file, or relative to other expected locations. For example, consider a case when the data signature at the beginning of a selected file format is 100 bytes long, whereas the corresponding data signatures of other selected file formats are less than 100 bytes. Selection unit 202 selects 100 bytes from the beginning of the file for which byte-pattern matching has to be performed. These 100 bytes are then compared to the data signature of the selected file formats for file format identification.

In case the relevant file format information is not available in the meta-data linked to the file, step 315 is performed directly. In step 315, selection unit 202 identifies the length of the longest data signature from a set of known file formats.

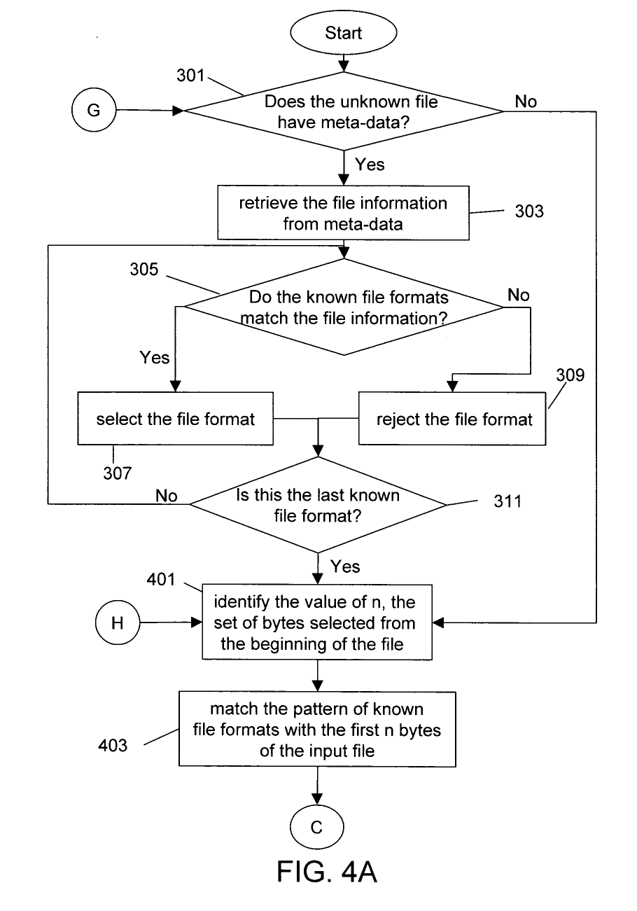

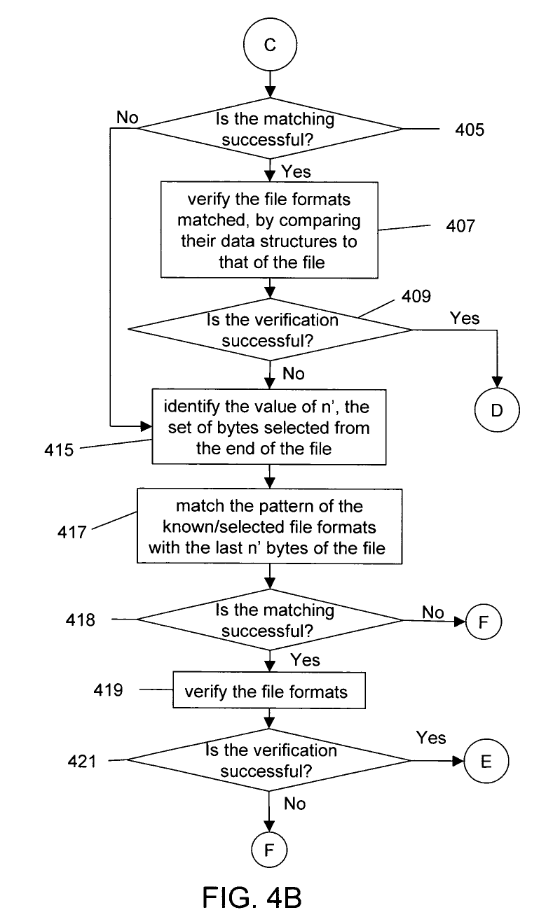

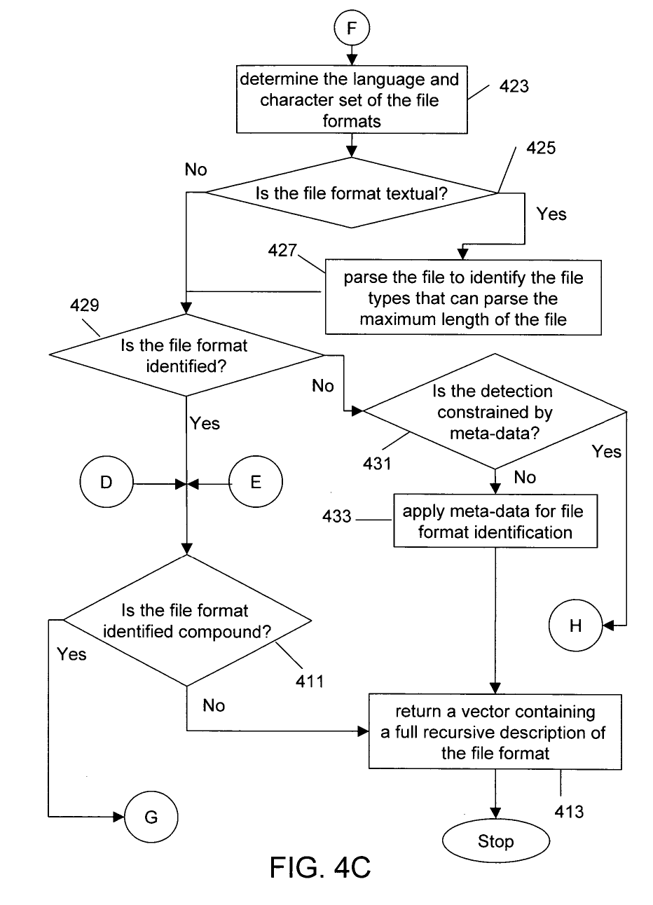

The steps involved in dynamically selecting the set of bytes from a file can be used for content-based, automatic file format detection. The steps involved in content-based, automatic file format identification are further described with the help of a flowchart in FIG. 4A, FIG. 4B and FIG. 4C.

In FIG. 4A, the method for content-based, automatic file format identification begins with the steps defined in FIG. 3. The method starts with step 301, and if the meta-data is available, it proceeds till step 311, and then goes to step 401, otherwise the method performs step 401 directly after step 301. In step 401, selection unit 202 identifies the value of ‘n’, where ‘n’ is the set of bytes selected at the beginning of the file for byte pattern matching. The value of ‘n’ is selected as the maximum number of bytes that are required to represent the data signature of the known or selected file formats. Selection unit 202 identifies the value ‘n’ in the manner as described in steps 313 and 315.

After determining the value of ‘n’, comparison unit 204 performs step 403. In step 403, comparison unit 204 chooses the first ‘n’ bytes of the file for which the file format identification is performed. Comparison unit 204 then matches this set of bytes with the data signature of the known/selected file formats. File types that are common are checked before obscure file types. This prioritized list of file formats is maintained by keeping an account of the file types frequently encountered in the past. The following example represents a data signature:
b[2]=0;
b[3]=8h;
b[7]=0;
b[11]=6h;
   where ‘b’ denotes a known file type; b[ ] denotes the location of the data signature in the file, and ‘h’ denotes the hexadecimal values of the bytes in the data signature of the known file type.

The data signature of each known/selected file format is checked in an iterative fashion. The following pseudo-code describes the steps performed by comparison unit 204 to compare the data signature mentioned above with the selected number of bytes at the beginning of the input file:

```
ITERATE FROM j = 0 TO j <= n − (length of the data signature)
INCREMENT BY 1
  BEGIN
    IF b[j] = 0h AND b[j+1] = 8h AND b[j+5] = 0h AND b[j+9] = 6h
THEN RETURN SUCCESS
  END
RETURN FALSE
```

The pseudo-code given above refers to an iterative loop that checks the hexadecimal data signature previously mentioned till the n^{th} hexadecimal digit. Steps 405 to 421 are illustrated in FIG. 4B. In step 405, comparison unit 204 checks if the data signature of at least one file format matches the byte-pattern of the file. The matching is considered successful if one or more data signatures match the byte-pattern of the file. Comparison unit 204 then selects the file formats for which the matching is successful. If the matching is successful, file format identification proceeds to step 407.

In step 407, verification unit 206 verifies the file formats for which the data signature matches the byte-pattern of the file. Verification unit 206 verifies the selected file formats by comparing their data structure with that of the file. The verification is performed based on the file formats for which the matching is successful in step 403. For example, in case of a ‘pdf’ file format, the verification in this case is performed by navigating the contents of the file. In step 409, verification unit 206 checks if the verification of a file format is successful. The verification process is successful if the data structure of the file matches that of at least one file. If the verification is successful, the file format identification proceeds to step 411. Steps 411 and 413 are illustrated in FIG. 4C.

In step 411, detection unit 208 compares the file format verified with a list of known compound file formats. If the compound file format is identified, the file format identification system 104 performs step 301, and iteratively identifies the sub-file formats within the compound file format. In step 411, if the file format is not compound, file format identification system 104 performs step 413. In step 413, file format identification system 104 returns the verified file format as the format of the file. The file format identified is returned as a vector. For example, a file identified as a Microsoft Word™ file may be represented as {Word [6]}.

In step 409, if the file format verification is not successful, or in step 405, if the matching is unsuccessful, selection unit 202 performs step 415 (FIG. 4B). In step 415, selection unit 202 identifies the value of n′ (n′ may be the same or different from ‘n’), where n′ is the set of bytes to be selected at the end of the input file. The value n′ is selected by a method identical to that described in steps 401. In step 415, once the number of last n′ bytes are selected, comparison unit 204 performs step 417. In step 417, comparison unit 204 matches the pattern of the last n′ bytes of the file to the data signature of the known/selected file formats. The matching performed in step 417 is identical to that performed for the first ‘n’ bytes, the only difference being in the location of the bytes selected. Comparison unit 204 then selects the file formats for which the data signature matches the pattern of last n′ bytes of the file. The following is an example of matching performed by comparison unit 204 is represented as a pseudo-code for the identification of the PKZIP™ archive. The pattern matching is performed by looking for the data signature 0x504b0506 at the end of the central directory structure.

```
ITERATE FROM j = n′ − 22 TO j >= 0 DECREMENT BY 1
  BEGIN
    IF b[j] = 50h AND b[j+1] = 4bh AND b[j+2] = 5h AND b[j+3] =
6h AND (b[j+20] < n′− j) THEN RETURN SUCCESS
  END
RETURN FALSE
```

Where ‘b’ denotes a known/selected file format, b[ ] denotes the location of the data signature, ‘h’ denotes hexadecimal representation, and n′ denotes the number of last n′ bytes selected for file format identification.

In step 418, comparison unit 204 checks if the matching is successful. The matching process is successful if the data signature of at least one file format matches the byte-pattern of the file. If the matching is successful in step 418, verification unit 206 verifies the selected file formats in step 419. Verification unit 206 performs this verification by matching the data structure of the file with that of known file formats. The verification process is performed by a method identical to the process described in step 407. In step 421, verification unit 206 computes the success of the verification process. The verification process is identified to be successful if there is at least one file format for which the data structure matches with that of the file. In step 421, if the verification is successful, the detection unit 208 performs step 411. In step 411, detection unit 208 compares the file format verified with a list of known compound file formats. In step 411, if the file format is not identified as compound, file format identification system 104 performs step 413. In step 413, file format identification system 104 returns the file format verified as the format of the file. For example, an exemplary zip file and its sub-file formats may be represented as follows:
{ZIP {ZIP/Word [8], ZIP/Text [ ], ZIP/UUEncode [ ] {ZIP/UUEncode/XML [1]}}}.

The file format identified is returned as a vector. Whereas, if in step 411 the file format matches a compound file format, file format identification system 104 performs step 301 and iteratively identifies the file formats of files within the compound file.

In case in step 421 no file format is verified, or if matching performed in step 418 is unsuccessful, data format identifier 210 performs step 423. Steps 423 to 425 are illustrated in FIG. 4C. In step 423, data format identifier 210 computes the language and character set of the file. A check to determine the language and character set is applied to select a representative set of textual file formats that may represent the input file. The language of the file is identified by comparing pointers to a particular language with the text of the file. The language of the file may also be identified from the meta-data linked to the file. For example, title (internal meta-data) ‘ [symbol] ’ of a text file may be used to identify that the text file is written in Arabic. Once the language of the file is identified, extraction unit 212 applies a set of file format-specific characters and syntax to the input file. For example, a file comprising an HTML code is likely to have high usage of characters [<and >], whereas a file containing a code written is ‘C’ language is likely to use the syntax ‘include stdio.h’. Once the language and character set of a file is identified, step 425 is performed. In step 425, the success of language and character set determination is identified. Step 423 is considered to be success if the language and character set of a text file format can be identified. If the file format is identified to be textual, step 427 is performed.

In step 427, parsers 214, each corresponding to a text file format identified by extraction unit in step 425, parse the text file. The file is parsed, based on known text-parsing algorithms. If a specific parser successfully parses the content of the file, it is assumed that the file matches the file format associated with that parser. A specific embodiment of this step may essentially contain parsers for many known document formats ranging from NROFF, HTML to Applix Words™. After parser 214 parses the file, file format identification unit 202 performs step 429.

If in step 425 the data type of the file format is not identified to be textual, step 429 is performed. At this stage the input file may be a binary, noise, or an unidentified file.

In step 429, it is checked if the file format is identified. If the file format of the input file is not identified, file format identification unit 202 performs step 431. In step 431, it is checked if meta-data has been used previously to constrain the search space of file formats. If the meta-data has been used previously, file format identification system 104 rejects the set of file formats selected by the meta-data and performs step 401. In this case, in step 401, the value of ‘n’ and n′ is selected from a set of known file formats. File format identification system 104 then iteratively performs steps 401 to 429 to identify the file format.

In step 429, if the file format has been identified, the document is checked to determine if it is a compound document in step 411, in the manner described earlier. If the pass was not constrained by meta-data then file format identification system 104 proceeds to step 433.

In step 433, two possible cases may exist. In the first case, if meta-data was not available for a textual file, then the file format identification system 104 returns the input file as an unknown simple text file with no embedded control or markup instructions. An example of a return vector in this case is {Unknown [Text [ ]]}. Whereas, in case of a non-textual file, file format identification system 104 returns that the file cannot be identified.

In the second case, if meta-data was available with the file (textual and non-textual), file format identification system 104 applies meta-data for format detection. The meta-data linked to the file performs a comparison through a set of identifiers of known file formats and returns the format that is indicated by the meta-data, as the format of the file. For example, for an HTML file the meta-data may read “<META http-equiv=“Content-Type” content=“text/html”>”. In this case file format identification system 104 reads the meta-data and returns the format of the file as {Unknown [text [HTML [ ]]]}.

The algorithm used by file format identification system 104 of the present invention enables it to be used as a stand-alone program, or a program operating as the module of a larger program or an operating system, such as the Windows™ operating system.

The set of instructions may include various instructions that instruct the processing machine to perform specific tasks, such as the steps that constitute the disclosed method. The set of instructions may be in the form of a program or software. The software may be in various forms such as system software or application software. Further, the software might be in the form of a collection of separate programs, or a program module with a larger program or a portion of a program module. The software might also include modular programming in the form of object-oriented programming. The processing of input data by the processing machine may be in response to user commands, to the results of previous processing, or to a request made by another processing machine.

The file format identification system 104, as described in the present invention, or any of its components, may be embodied in the form of a processing machine. Typical examples of a processing machine include a general-purpose computer, a programmed microprocessor, a micro-controller, a peripheral integrated circuit element, and other devices or arrangements of devices which are capable of implementing the steps that constitute the disclosed invention.

A person skilled in the art can appreciate that it is not necessary that the various processing machines and/or storage elements be physically located at the same geographical location. The processing machines and/or storage elements may be located in geographically distinct locations and be connected to each other to enable communication. Various communication technologies may be used to enable communication between the processing machines and/or storage elements. Such technologies include the connection of the processing machines and/or storage elements in the form of a network. The network can be an intranet, an extranet, the Internet, or any client server models that enable communication. Such communication technologies may use various protocols such as TCP/IP, UDP, ATM or OSI.

While the preferred embodiments of the invention have been illustrated and described, it will be clear that the invention is not limited to these embodiments only. Numerous modifications, changes, variations, substitutions and equivalents will be apparent to those skilled in the art, without departing from the spirit and scope of the invention, as described in the claims.

1. A method for byte-pattern recognition of an input file, the method comprising the steps of:
a. selecting a set of bytes, the length of set of bytes being computed based on the length of the data signatures of the known file formats, wherein the set of bytes being selected in the input file at a location corresponding to the digital signature of the file formats;
b. matching the data signature of the known file formats with the selected set of bytes, whereby the matching successfully returns one or more file formats that match the selected set of bytes in the input file;
c. verifying the file format, the verification is performed for the file formats for which the data signature matches the selected set of bytes in the input file, wherein verification is performed by comparing the data structure of the input file with the data structure of the file formats that have identical data signature with the input file; and
d. returning the file format that matches the byte-pattern and is verified, as the format of the file.

2. The method as disclosed in claim 1 further comprising the steps of:
a. determining if the file format verified is compound, wherein the step is performed by comparing the file format to a record of known compound file formats; and
b. identifying the formats of the files present in the identified compound file.

3. The method as disclosed in claim 1 further comprising the steps of:
a. retrieving relevant file format information from the meta-data linked to the file; and
b. selecting the file formats that match the file format information, wherein the file formats that match the file format information are selected for determining the length of the set of bytes, the set of bytes being selected for byte-pattern recognition.

4. The method as disclosed in claim 1 further comprising the step of returning a vector containing a full recursive description of the file format that matches the byte-pattern of the input file.

5. A method for content-based, automatic file format identification, the method comprising the steps of:
a. selecting a set of bytes, the length of set of bytes being computed based on the length of the data signatures of the known file formats, wherein the set of bytes being selected in the input file at a location corresponding to the digital signature of the file formats;
b. matching the data signature of the known file formats with the selected set of bytes, whereby the matching successfully returns one or more file formats that match the selected set of bytes in the input file;
if the data signature of one or more file formats matches the selected set of bytes, performing step c and d;
c. verifying the file formats, the verification being performed for the file formats for which the data signature matches the selected set of bytes in the input file, wherein verification is performed by comparing the data structure of the input file with the data structure of the file formats that have identical data signature with the input file; and
d. returning the file format that matches the byte-pattern and is verified, as the file format of the file.
else performing steps e to i;
e. identifying the data type, the data type being identified from binary and text base data types;
if the data type is identified to be textual, performing steps f to h:
f. identifying the textual file format;
else if the data type is not identified to be textual, performing steps g to h:
g. applying meta-data for non-textual file format detection; and
h. returning the file-format that is successfully confirmed by applying the meta-data, as the file format of the file.

6. The method as disclosed in claim 5 further comprises the steps of:
a. determining if the file format verified is compound, wherein the step is performed by comparing the file format to a record of known compound file formats; and
b. identifying the file formats of the files in the compound file format.

7. The method as disclosed in claim 5, wherein determining the number of bytes selected for file format identification further comprises the steps of:
a. retrieving relevant file format information from the meta-data linked to the file; and
b. selecting the file formats that match the file format information, wherein the file formats that match the file format information are selected for determining the length of the set of bytes, the set of bytes being selected for byte-pattern recognition.

8. The method as disclosed in claim 5 further comprises the step of returning a vector containing a full recursive description of the file format that is returned as the format of the input file.

9. A method for content-based, automatic file format identification, the method comprising the steps of:
a. selecting a set of first ‘n’ bytes of the input file, wherein the value of ‘n’ is chosen based on the length of the longest data signature at the beginning of the known file formats; and
b. matching the byte-pattern of the selected first ‘n’ bytes with the data signature at the beginning of the known file formats;
if the data signature of the known file formats does not match the pattern of first ‘n’ bytes, performing steps c to d;
c. selecting a set of last n′ bytes of the input file, wherein the value of n′ is chosen based on the length of the longest data signature at the end of the known file formats; and
d. matching the byte-pattern of the selected last n′ bytes with the data signature at the end of known file formats;
if the data signature of the known file formats does not match the pattern of last n′ bytes, performing the step e;
e. determining the language and character set of the input file, the language and character set determined to identify text file formats the input file can have;
if the file type is identified to be textual, then performing steps f to h:
f. parsing the text of the input file, each parser corresponding to a file format for which the character set is identified, wherein the text is parsed to identify the file format of the input file;
if the textual file format is identified, performing g:
g. selecting the file format that can parse maximum length of the text file as the file format; and
else if parsing is unsuccessful, performing h:
h. applying meta-data to identify the textual file format;
else if no textual data type is identified, performing i:
i. applying meta-data, the meta-data applied to identify the file format;
else, if the data signature of the known file formats matches the pattern of last n′ bytes, performing steps j to k;
j. verifying the file format, wherein verification is performed by comparing the data structure of the file with the data structure of the file formats that have identical data signature with the file; and
k. identifying the file format that matches and is verified, as the file format of the file;
else if the data signature of the known file formats match the pattern of first n bytes, performing steps of j to k;
l. determining whether the file format identified matches a compound file format, wherein the step being performed if the file format is identified; and
m. identifying the file formats of the files in the identified compound file format.

10. The method as disclosed in claim 9 further comprises the steps of:
a. retrieving relevant file format information from the meta-data linked to the file; and
b. selecting the file types that match the file information provided by the meta-data, wherein the file formats that match the data signature are selected for file format identification.

11. The method as disclosed in claim 9 further comprises the step of returning a vector containing a full recursive description of one or more file formats identified.

12. The method as disclosed in claim 9, wherein the step of determining the language and character set of the file comprises the step of using meta-data, the meta-data being used for providing essential information about the language type of the file.

13. The method as disclosed in claim 9, further comprises the steps of:
a. checking if meta-data has not been used previously for selecting a set of file formats, the file formats selected for byte pattern recognition;
if meta-data has been used previously for selecting a set of file formats, performing steps b to c:
b. rejecting the meta-data and the file formats selected by meta-data; and
c. performing file format identification with a list of known file formats; and
if meta-data has not been used previously for selecting a set of file formats, performing step d:
d. applying meta-data to identify both textual non-textual file formats.

14. A system for content-based, automatic file format identification, the system comprising:
a. means for selecting, means for selecting identifies a set of bytes in the file, the bytes being selected based on the length of the data signature of the known file formats;
b. means for comparing, the means for comparing matches the data signature of file formats with the pre-selected number of bytes in the file;
c. means for verifying, the means for verifying compares the data structure of the file with that of the known file formats;
d. means for comparing the representative language and character sets of known file formats to the file, the language and character set being determined for text file formats; and
e. one or more parsers, each parser representing a particular text file format, the file being parsed for identifying a text file format;

15. The system as described in claim 15 further comprising:
a. means for identifying a data format, wherein the data format is either text or binary; and
b. means for detecting a compound file format.

16. The method as recited in claim 1, wherein the method is implemented as a computer program product.

17. The method as recited in claim 5, wherein the method is implemented as a computer program product.

18. The method as recited in claim 10, wherein the method is implemented as a computer program product.
